(19) United States
(12) Patent Application Publication
(10) Pub. No.: US 2007/0100713 A1
(43) Pub. Date: May 3, 2007

(54) Identifying inventory items within an image

(76) Inventors: Jim Del Favero, Redwood City, CA (US); Kent McPhee, Edmonton (CA)

Correspondence Address: FENWICK & WEST LLP, SILICON VALLEY CENTER, 801 CALIFORNIA STREET, MOUNTAIN VIEW, CA, 94041, US

(21) Appl. No.: 11/267,551

(22) Filed: Nov. 3, 2005

(51) Int. Cl. G06F 17/50

(52) U.S. Cl. 705/29

(57) ABSTRACT

In various embodiments, the present invention provides methods and systems for isolating and capturing an image of an inventory item from an image that contains multiple items and/or extraneous space. The user interface allows the user to import an image into an application, identify one or more regions of the image as corresponding to separate inventory items, and create inventory records corresponding to those items or update existing inventory records to include the images of those items.

### BACKGROUND

This invention relates to systems and methods of creating and maintaining inventories. Inventories are used, for example, in homes and in businesses. An inventory in the context of a home can be used to maintain an itemized list of objects in one's possession. An inventory in the context of a business can be used to maintain a record of the goods and materials in stock. Inventories can be stored in databases where each record corresponds to one item. The database may also store descriptive information about each item, such as purchase date, price, current value, and the like. By keeping the inventory current, users can quickly access a summary of their belongings, enabling them either to use the information themselves to make decisions or to share this information with other entities.

Many products are available in the market to assist users in generating and maintaining inventories. Examples of inventory programs are AssetManage Home Inventory by Liberty Street Software (available at http://www.libertystreet.com/Asset-Home-Inventory.htm), Everything I Own, by Mycroft Computing (available at http://www.mycroftcomputing.com/eiown.html), Frostbow Home Inventory by Frostbow Software (available at http://frostbow.com/products/home inventory.html), and QuickBooks: Point of Sale 4.0 (available at http://quickbooks.intuit.com). Some existing inventory programs allow users to append one or more pictures of an item to an existing inventory record. Methods and processes of adding items to inventories by selecting images to represent the items in the inventory database have been described in application Ser. No. 11/123,810, filed May 6, 2005, titled “Image-Based Inventory Tracking and Reports,” which is incorporated herein by reference in its entirety. According to these systems and methods, a user can import an image into an application, and by selecting an image to represent an item to be added to the inventory, a new record is created in the inventory database. The user interface allows the user to add records of items, organize view of the data, and modify records of items all through the user's interaction with the image representing the item. Thus, a user can take a picture of each of their belongings and use each picture to represent the corresponding item in the inventory.

Users may want to capture each item individually to avoid including extraneous information in the image and to avoid confusion over which item in the picture corresponds to each inventory record. Existing tools require users to provide a picture of each item. This can be accomplished by photographing each item individually or by photographing a group of items and using a separate photo editing application to create a new image from a portion of an original image and importing or attaching the new image to the inventory. Both methods require a significant time investment to individually capture images of inventory items.

### SUMMARY

In various embodiments, the present invention provides methods and systems for isolating and capturing an image of an inventory item from an image that contains multiple items and/or extraneous space. The user interface allows the user to import an image into an application, identify one or more portions of the image as corresponding to separate inventory items, and create inventory records corresponding to those items or update existing inventory records to include the images of those items.

In one implementation, the creation of a new record in the inventory database is initiated by a user selecting a portion of an image, a portion corresponding to an item to be added to the inventory. The inventory program stores a new record for the item, the record containing a reference to an image that includes the selected portion from the original image. In one variation, a plurality of portions is selected from the original image. Then, each of the portions is used to create a respective image to represent an item to be added to the inventory.

In another implementation, a user selects a portion of an image, the portion corresponding to an item for which a record already exists in the database. In response to the selection, the inventory program stores a new image that includes the selected portion of the original image. The existing record for the item can be updated to include a reference to the new image.

### BRIEF DESCRIPTION OF THE DRAWINGS

FIG. 1 is a flow chart illustrating one embodiment of a method of creating new inventory items from selections within an image.

FIG. 2 is a screen shot of one embodiment of an image editor after an image has been imported.

FIG. 3 is a screen shot of the image editor of FIG. 2 after several portions of the image have been selected.

FIG. 4 is a screen shot of one embodiment of an image bin after the several selections within the image in FIG. 3 have been added.

FIG. 5 is an illustration of one embodiment of the photo view of the inventory items from the several selections within the image after the user has selected to add new inventory items.

FIG. 6 is an illustration of one embodiment of the list view of the inventory items from the several selections within the image after the user has selected to add new inventory items.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

In various embodiments, the present invention provides software products, methods, and systems for creating, modifying, or updating records describing inventory items based on selections within an image that has been obtained in an inventory program. The present invention can be implemented in personal or commercial financial management software packages including, for example, accounting or tax preparation software. The present invention, in other embodiments, can also be implemented in an inventory program in a stand-alone application outside of a financial management software package. Alternatively or additionally, the application can be remotely hosted and accessed over a network, such as the Internet, a LAN, a WAN, a wireless network, a private network or a virtual private network. The present invention will be described in the context of a Home Inventory software program as a feature included in a financial management software package, such as Quicken® or QuickBooks® by Intuit, Inc. of Mountain View, Calif., or Microsoft Money by Microsoft Corporation of Redmond, Wash., that has been loaded onto a user's computer. In the following examples, the financial management software package is included on a computer running a version of Windows developed by Microsoft Corporation. The present invention, in other embodiments, can be adapted to apply to Mac OS developed by Apple Computer, Inc. of Cupertino, Calif., various flavors of Linux, UNIX, Palm OS, and/or other operating systems. It will be readily understood by those ordinarily skilled in the art that the software products, methods and systems could also be applied in business inventories or other inventory contexts outside the home all without departing from the teachings of the invention disclosed herein. Furthermore, several figures are presented as screen shots depicting examples of the user interface as it might appear on a display screen or other output device. The particular screen layouts, appearance, and terminology as depicted and described herein, are intended to be illustrative and exemplary, and in no way limit the scope of the invention as claimed.

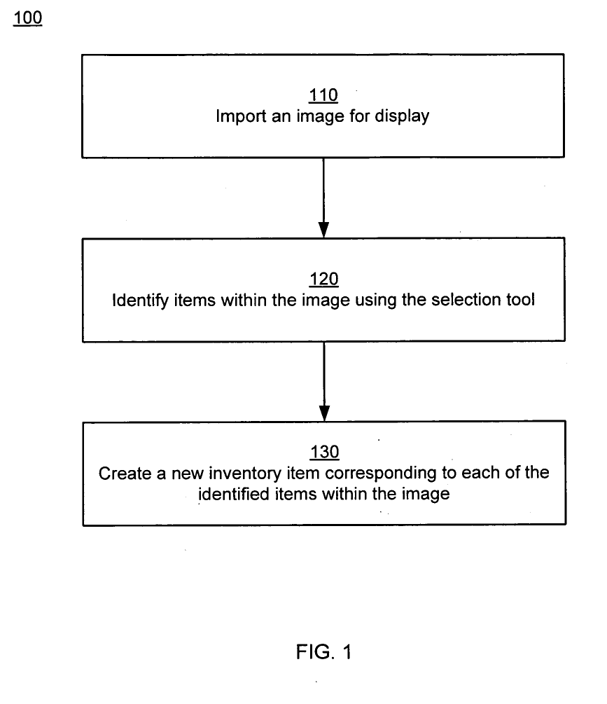

FIG. 1 is a flow chart illustrating one embodiment of a method 100 of creating new inventory items from selections within an image.

First, an image is imported 10 into the inventory application for display. The image can imported from a device such as a digital camera, for example. The image may be imported from a local file system, imported from a remote location over a network, or imported from an email attachment. Alternatively, the image can be obtained in the inventory software application by another means. In one embodiment, the user drags and drops the image into the inventory application. In another embodiment, the image is already present within the inventory application, for example, because it is associated with an item in the inventory record for that item. The image is displayed within the application.

Then, items within the image are identified 120. A portion of the image is identified as corresponding to each item. In one implementation, a user selects a rectangular area by dragging a cursor diagonally over the desired section of the image. In another implementation, the user selects a free form area by dragging the cursor around the perimeter of the desired portion of the image. In one embodiment, multiple selections within an image that together correspond to one item can be treated like a single selection despite being non-contiguous. In one variation, individual selections of a plurality of items can be made within one image, and the selection areas can overlap. In one embodiment, a selection tool is used to identify the portion of the image corresponding to each of the items. Alternatively, the portion of the image corresponding to an item can be automatically detected using pattern recognition, color similarity detection, outline detection, or any other method known to those of skill in the art. In one embodiment, portions of the image corresponding to identified items are saved as separate images.

A new inventory record corresponding to each of the identified items within the image is created in step 130. In one embodiment, each new inventory record contains a reference to the corresponding portion of the image identified within the original image. In one embodiment, the actual selection area identified from the original image is adjusted automatically for the characteristics of the image. For example, a user may select a general area from the original image, and then pattern recognition, color similarity detection, outline detection, or any other technique known to those of skill in the art can be employed to determine the precise perimeter of the selected portion of the image. In one embodiment, after all selections have been made, the user selects an “Add New Items” button. Activating this command causes a new item corresponding to each selection to be added to the inventory. Alternatively, the user can select an “Apply” button to add separate images of the selected portions of the original image to an image bin within the application.

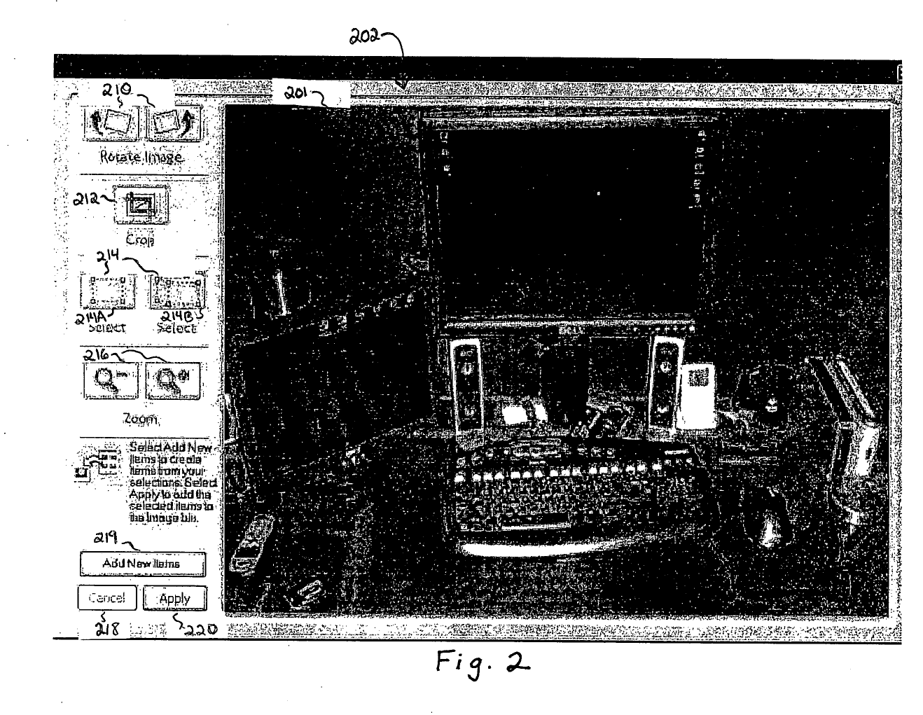

FIG. 2 is a screen shot of one embodiment of an image editor after an image 201 has been imported. In this example, the user has taken a photograph that includes a number of computer components to be added to the inventory and imported the image 201 into an inventory program. The image editor comprises a workspace 202 to display the image 201 and several tools to manipulate and edit the image 201. The rotate buttons 210 rotate the displayed image 201 clockwise or counter-clockwise. The crop button 212 crops the image 201. The user can select the selection tool buttons 214 to activate the selection tool. As described above, in this embodiment, a user selects a rectangular area by dragging a cursor diagonally over the desired section of the image when the selection tool is active. The zoom tool 216 to increases or decreases the size of the image 201. After the user has selected the desired selection areas, the user can select the Cancel button 218 to clear the selections, the Add New Items button 219 to create records in the inventory for the items identified in each of the selections, or the Apply button 220 to add the selected portions of the image 201 to the image bin as separate images. In one embodiment, buttons 218, 219, and 220 are not activated until a selection of a portion of the image 201 has been made.

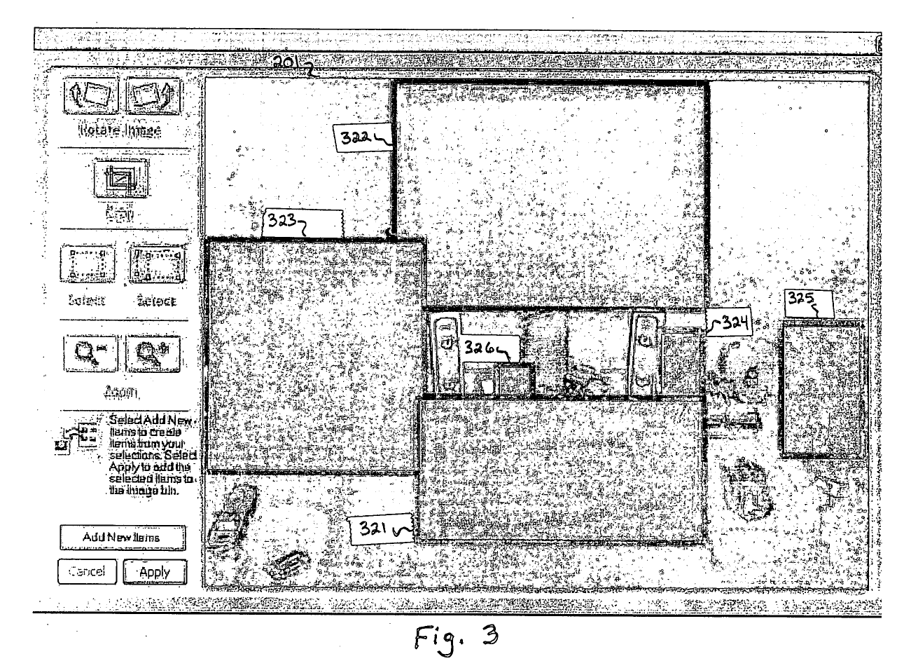

FIG. 3 is a screen shot of the image editor of FIG. 2 after several portions of the image 201 have been selected. Rectangles 321-326 correspond to selections of image 201 that were made using selection tool 214. In one embodiment, the selected portions of the image 201 are displayed to the user within the image 201. For example, the selected portions may be indicted by a fill color and/or a color highlight and/or a distinctive outline such as a bold line, a dotted line, or an animated dotted line. Alternatively, any other indication of the selected portion could also be used. As shown in this embodiment, selection tool 214 comprises two buttons 214A and 214B. Button 214A is used to select a single portion of image 201. Button 214B is used to select multiple portions of image 201. Alternatively, the selection tool 214 could be activated by selecting a single button that could be used for identifying a single or multiple selection areas from image 201.

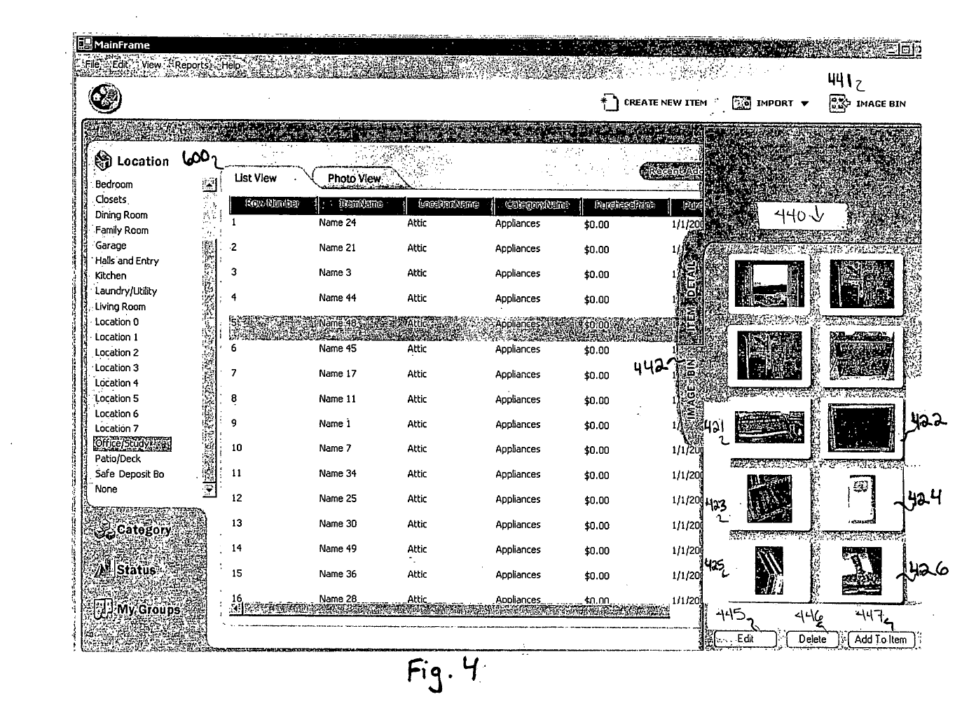

FIG. 4 is a screen shot of one embodiment of an image bin 440 after the several selections of the image in FIG. 3 have been added. As shown in FIG. 4, thumbnail versions 421-426 of the selected areas 321-326 of image 201 are displayed in the image bin 440. The image bin 440 is a location in which thumbnail versions of images such as versions 421-426 are stored until a user associates the image with an inventory item. In this embodiment, the thumbnail versions 421-426 are sized to fit within equal-sized boxes within the image bin 440. In this example user interface, a user can access the image bin 440 by selecting the image bin tab 442. Alternatively, a user can access the image bin 440 by selecting the image bin button 441. The image bin 440 also comprises an edit button 445, a delete button 446, and an Add to Item button 447. The user first selects a thumbnail version of an image in the image bin 440 and then selects one of these buttons 445-447 to take action on that image. If the user then selects the edit button 446, the corresponding full version of the image is displayed in the workspace 202 of the image editor shown in FIG. 2. The user can then use the image editor tools to manipulate the image as described above. If a user selects the delete button 446, the thumbnail version and the corresponding full version of the image are deleted from the image bin 440 and the application. To use the Add to Item button 447, in one embodiment, the user first selects an item from the list of items shown in the list view 600 to highlight it. Then the user selects the thumbnail version of the image the user wishes to add to the highlighted item. When the user then selects the Add to Item button 447, the highlighted item in the inventory database is automatically updated to include the selected image. Alternatively, the user can add an image to an inventory item by selecting a thumbnail version of an image and dragging and dropping it on an item from the list of items shown in the list view 600. In one embodiment, the selected thumbnail image is automatically deleted from the image bin 440 after a copy of the image has been added to an inventory item. In another embodiment, the selected thumbnail image remains in the image bin 440 after it has been added to an inventory item.

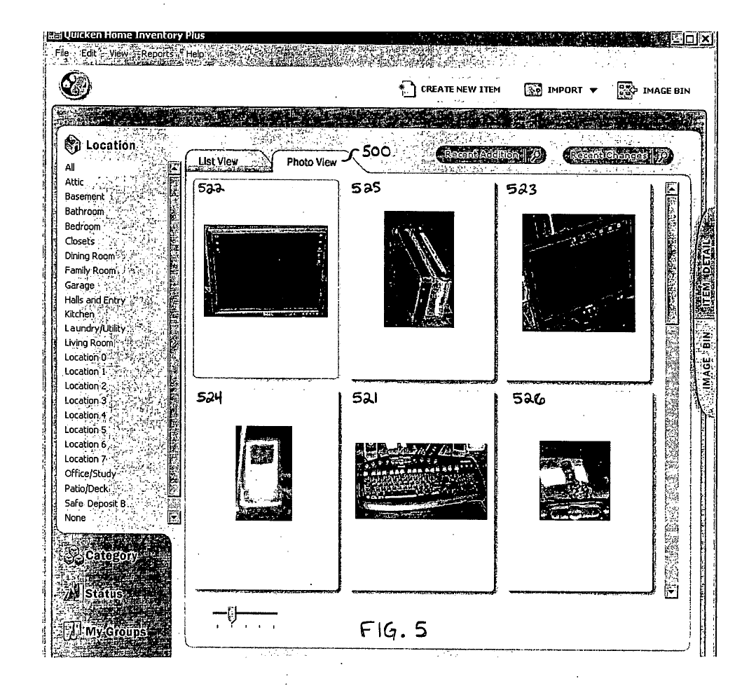

FIG. 5 is an illustration of one embodiment of the photo view 500 of the inventory items created from the several selections 321-326 of the image 201 after the user has chosen to add new inventory items by selecting the Add New Items button 219. Each of the images 521-526 corresponds to an item in the inventory. Images 521-526 can be down-sampled versions of the selections 321-326 within the image 201.

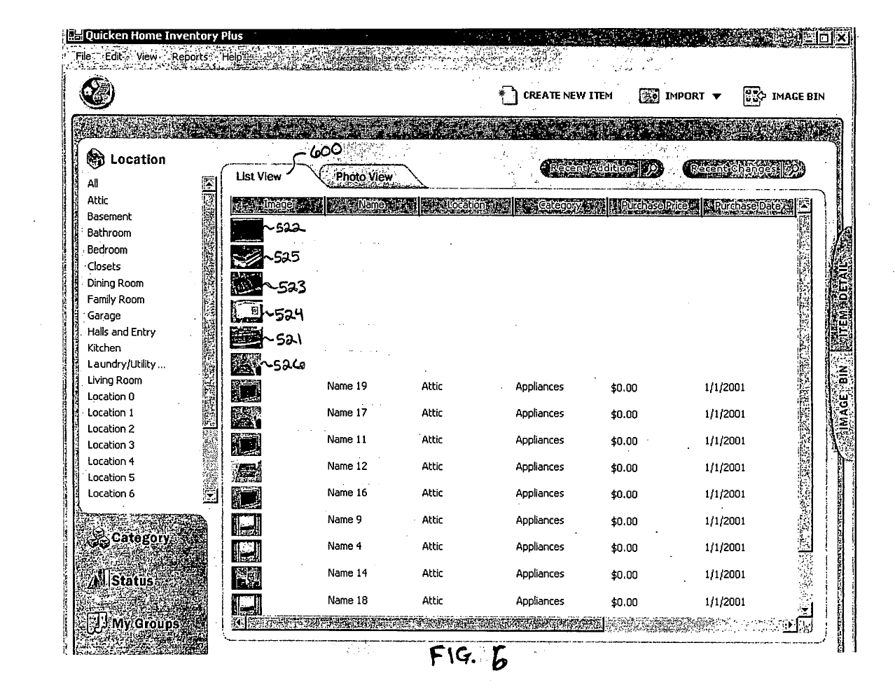

FIG. 6 is an illustration of one embodiment of the list view 600 of the inventory items from the several selections 321-326 within the image 201 after the user has added new inventory items by selecting the Add New Items button 219. Each row in the list view corresponds to an item in the inventory. Each record for a new inventory item contains a reference to the associated image. In this embodiment, the reference to the associated image is a down-sampled or thumbnail image such as images 521-526. In this embodiment, the newly added inventory items with images 521-526 have blank entries for the remaining fields as a default upon creation. A user can optionally edit the inventory records by opening an item detail dialog box (not shown). For additional examples of methods of editing inventory records, refer to application Ser. No. 11/123,810, filed May 6, 2005, titled “Image-Based Inventory Tracking and Reports.”

The present invention has been described above in particular detail in the context of a home inventory application. The present invention can also be used for other purposes. For example, a home inspector or an insurance adjuster may be on-site only a brief time to collect a few photographs that include multiple items. The home inspector or insurance adjuster can easily manipulate these photographs back at the office in order to store individual records of each item associated with an image of that item. As another example, individual headshots can be captured from a group photograph and a record for each headshot can be automatically added to a database of people. Using this functionality, a group photograph from a business conference can be quickly turned into a database of contacts with each entry associated with the face of the participant. In the same way, a class photograph can be quickly turned into an alumni database with the associated pictures of the members, and old group family photographs can be quickly turned into a genealogical database linked to family members' individual pictures. Those of skill in the art will appreciate that the invention can be implemented in a variety of other contexts.

Those of skill in the art will also appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method of generating a record for an item in an inventory database, the method comprising:
obtaining a first image in an inventory software application; and
responsive to a user selecting a portion of the first image corresponding to an item to be added to the inventory, creating a second image containing the portion of the first image and generating a record for the item in the inventory database comprising a reference to the second image.

2. The method of claim 1, wherein obtaining a first image comprises importing a first image into an inventory software application.

3. The method of claim 2, wherein importing a first image comprises at least one selected from a group consisting of importing from a local file system, importing from a remote file system, importing an image received from a device, and importing an image from an email attachment.

4. The method of claim 1, wherein obtaining a first image comprises importing a first image captured by digital camera into an inventory software application.

5. The method of claim 1, wherein the inventory database is associated with a financial services software package.

6. The method of claim 1, wherein the record for the item in the inventory database comprises a down sampled version of the second image.

7. The method of claim 1, wherein the record for the item in the inventory database comprises a thumbnail version of the second image.

8. The method of claim 1, wherein the inventory software application comprises one selected from a group consisting of a home inventory software application and a business inventory software application.

9. The method of claim 1, wherein the portion of the first image corresponding to an item to be added to the inventory is non-contiguous.

10. A computer-implemented method of generating an inventory record for each of a plurality of items based on a plurality of selected portions of a first image, the method comprising:
displaying in a workspace within an inventory software application the first image; and
responsive to a user selecting a plurality of portions of the first image, each portion corresponding to an item to be added to the inventory, creating a plurality of second images, each second image containing one of the plurality of portions of the first image, and generating a record in the inventory database for each item, each record comprising a reference to the second image containing the portion of the first image corresponding to the item.

11. A computer-implemented method of updating a record for an item in an inventory database, the method comprising:
displaying in a workspace within an inventory software application the first image; and
responsive to a user selecting a portion of the first image corresponding to an item in the inventory, creating a second image containing the portion of the first image and updating the record for the item in the inventory database to include a reference to the second image.

12. The method of claim 11, wherein the inventory database is associated with a financial services software package.

13. A user interface for an inventory software application comprising:
a workspace for displaying a first image within the inventory software application; and
a selection tool for selecting a region of the first image corresponding to an item to be added to the inventory.

14. A computer program product for generating a record for an item in an inventory database, the computer program product stored on a computer readable medium, and adapted to perform the operations of:
obtaining a first image in an inventory software application; and
responsive to a user selecting a portion of the first image corresponding to an item to be added to the inventory, creating a second image containing the portion of the first image and generating a record for the item in the inventory database comprising a reference to the second image.

15. The computer program product of claim 14, wherein obtaining a first image comprises importing a first image into an inventory software application.

16. The computer program product of claim 15, wherein importing a first image comprises at least one selected from a group consisting of importing from a local file system, importing from a remote file system, importing an image received from a device, and importing an image from an email attachment.

17. The computer program product of claim 14, wherein the inventory database is associated with a financial services software package.

18. A computer program product for generating an inventory record for each of a plurality of items based on a plurality of selected portions of a first image, the computer program product stored on a computer readable medium, and adapted to perform the operations of:
displaying in a workspace within an inventory software application the first image; and
responsive to a user selecting a plurality of portions of the first image, each portion corresponding to an item to be added to the inventory, creating a plurality of second images, each second image containing one of the plurality of portions of the first image, and generating a record in the inventory database for each item, each record comprising a reference to the second image containing the portion of the first image corresponding to the item.

19. A computer program product for updating a record for an item in an inventory database, the computer program product stored on a computer readable medium, and adapted to perform the operations of:
displaying in a workspace within an inventory software application the first image; and
responsive to a user selecting a portion of the first image corresponding to an item in the inventory, creating a second image containing the portion of the first image and updating the record for the item in the inventory database to include a reference to the second image.

20. The computer program product of claim 19, wherein the inventory database is associated with a financial services software package.
